(19) United States
(12) Patent Application Publication
(10) Pub. No.: US 2025/0208908 A1
(43) Pub. Date: Jun. 26, 2025

(54) AUTOMATED PARALLELIZATION FOR EXECUTION

(71) Applicant: American Express Travel Related Services Company, Inc., New York, NY (US)

(72) Inventors: Joseph Stephen Cullins, Phoenix, AZ (US); Prakasam Duraisamy, Phoenix, AZ (US); Ryan Edward O'Donnell, Peoria, AZ (US); William C. Ready, Carnation, WA (US); Jagadeesh Reddy Yeddula, Phoenix, AZ (US)

(21) Appl. No.: 18/394,837

(22) Filed: Dec. 22, 2023

(51) Int. Cl. G06F 9/48; G06F 9/38

(52) U.S. Cl. CPC G06F 9/4881; G06F 9/3877

(57) ABSTRACT

Disclosed are various embodiments for automated parallelization of logical rules. A first computing device can determine individual dependencies between individual ones of a plurality of objects stored in the memory, each of the objects comprising a node representing a logical rule and at least one edge representing variable linked to the logical rule. The first computing device can then divide the plurality of objects into a plurality of groups of objects based at least in part on the individual dependencies between the individual ones of the objects, wherein individual objects within individual ones of the groups of objects are independent of individual objects within other ones of the groups of objects. Subsequently, the first computing device can assign individual ones of the groups of objects to individual computing devices for execution in parallel, the individual computing devices being separate from the first computing device.

### BACKGROUND

No-code and low-code environments allow for individuals with little to no programming experience to develop applications for various purposes. These no-code and low-code environments allow for individuals to specify rules, conditions, actions, triggers, etc. These rules, conditions, actions, triggers, etc. can then be converted into computer-executable code for execution as an application.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing illustrating the operation of various embodiments of the present disclosure.

FIG. 2 is a drawing illustrating the operation of various embodiments of the present disclosure.

FIG. 3 is a drawing of a network environment according to various embodiments of the present disclosure.

FIG. 4 is a flowchart illustrating one example of functionality implemented as portions of an application executed in a computing environment in the network environment of FIG. 3 according to various embodiments of the present disclosure.

FIG. 5 is a flowchart illustrating one example of functionality implemented as portions of an application executed in a computing environment in the network environment of FIG. 3 according to various embodiments of the present disclosure.

### DETAILED DESCRIPTION

Disclosed are various approaches for automatically splitting serialized workloads into parallel workloads that can be performed in parallel. Many rapid application development (RAD) suites allow for individuals with little to no programming experience to specify various rules, functions, conditions, or triggers that represent logical blocks of execution. These logical blocks of execution, however, are not written in human readable source code of a programming language that could be compiled into an executable program. Accordingly, the logical blocks of execution are often written sequentially or serial under the assumption that the logical blocks of execution would be executed in the order they are written or arranged.

However, many of these logical blocks of execution are often independent of each other. For example, a second logical block of execution might represent a business rule that is dependent on the results or output of a first logical block of execution. Meanwhile, a third logical block of execution might have no dependencies but would be expected to execute after the first and second logical blocks of execution have executed even though the third logical block of execution could be executed in parallel with the first and second logical blocks of execution.

Accordingly, various embodiments of the present disclosure improve the performance of sequences of logical blocks of execution by automatically parallelizing the workloads. For example, the various embodiments of the present disclosure can identify logical blocks of execution that are independent of each other. The various embodiments of the present disclosure could then assign at least some of these independent logical blocks of execution to separate computing resources or devices so that they could be executed in parallel without impacting each other, thereby improving performance.

Various embodiments of the present disclosure could be used in a variety of scenarios. For example, when evaluating whether to approve or deny a transaction, a number of logical rules could be specified.

For instance, different logical rules could be specified to calculate a fraud score, which represents the likelihood that a transaction is fraudulent, when a request to authorize a transaction is received. A first logical rule could calculate a fraud score based on the amount of the transaction compared to previous transactions of the payee. A second logical rule could calculate a fraud score based on where the transaction geographically occurred compared to where the payee typically conducts business or makes payments. Meanwhile, a third logical rule could calculate a fraud score based on whether the transaction occurred at the same or similar type of merchant that the payee typically conducts business with. Meanwhile, a fourth logical rule could calculate a total fraud score based at least in part on the results of the fraud scores calculated using the three previously described logical rules (e.g., by calculating an average or a weighted average of the three previously described fraud scores).

In addition to fraud detection, other logical rules could be specified to perform other checks to determine whether to authorize the transaction. These logical rules could represent independent considerations for authorizing a transaction separate from whether the transaction is fraudulent. For example, one logical rule could be specified to determine whether the user has a sufficient account balance or spending power to make the purchase. A second logical rule could be specified to determine whether to authorize the transaction even if the user has an insufficient account balance or spending power (e.g., to allow a user to overdraw his or her account or to go above his or her credit limit).

Continuing this example, many RAD suites or similar business rules engines would allow for someone to specify or define the previously described example rules. For the sake of simplicity, the RAD suites or business rules engines are normally configured to execute the logical rules in the order in which they are specified. Accordingly, if a user were to specify the example logical rules in the order they were previously described, the four previously described fraud detection rules would be evaluated first, followed by the two previously described rules that take into account financial considerations when authorizing a transaction.

However, many of these rules can be evaluated in parallel because they do not depend on the results of another rule. For example, the first three logical rules related to fraud detection could be performed in parallel, while the fourth logical rule related to fraud detection could be performed once the first three rules were evaluated. As another example, other previously described logical rules related to authorizing the transaction could be performed in parallel to the fraud detection rules as well as in parallel to each other. Accordingly, a RAD suite or business rules engine that could automatically identify logical rules that could be processed in parallel and assign the identified logical rules to separate computing resources could be expected to perform significantly faster and more efficiently compared to traditional RAD suites or business rules engines. Using the previous example, a business rules engine employing various embodiments of the present disclosure could be expected to process and authorize the same number of transactions far more quickly or be able to process and authorize a far greater number of transactions within existing time expectations.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

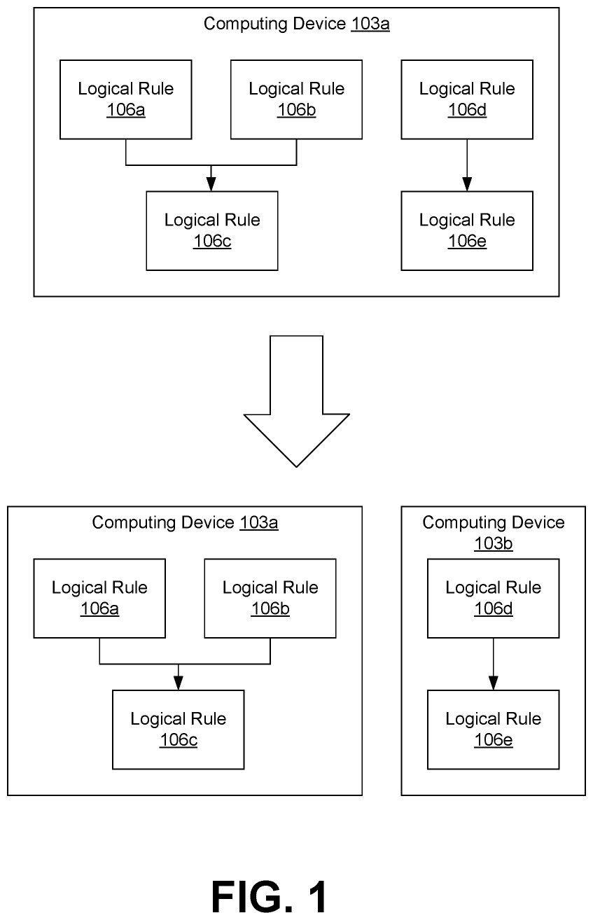

FIG. 1 provides an illustrative example of the present disclosure in its various embodiments. As shown, a computing device 103a can have multiple logical rules 106 (e.g., logical rules 106a, 106b, 106c, 106d, and 106e) assigned to the computing device 103a for execution. Individual logical rules 106 can have dependencies, such that a first logical rule 106 must be evaluated or executed before a subsequent logical rule 106 can be evaluated or executed. For example, before logical rule 106c can be evaluated or executed, logical rules 106a and 106b must first be evaluated or executed. As another example, before logical rule 106e can be executed or evaluated, logical rule 106d must be executed or evaluated.

However, in the example depicted in FIG. 1, logical rules 106a, 106b, and 106c are independent of logical rules 106d and 106e. Accordingly, logical rules 106a, 106b, and 106c could be executed in parallel with logical rules 106d and 106e. Therefore, various embodiments of the present disclosure could cause logical rules 106a, 106b, and 106c to be executed by a first computing device 103a and logical rules 106d and 106e to be executed by a second computing device 103b. Therefore, various embodiments of the present disclosure could cause logical rules 106d and 106e to be moved from the first computing device 103a to the second computing device 103b for execution in parallel. Moreover, by utilizing the resources of separate computing devices 103, rather than the shared resources of the same computing device 103, logical rules 106a, 106b, 106c, 106d, and 106e can be executed with greater performance.

Although the example depicted in FIG. 1 shows the migration of logical rules 106 from a first computing device 103 to a second computing device 103 to improve performance by taking advantage of opportunities for parallelization of execution or evaluation of the logical rules 106, the same or similar approaches could be used to migrate logical rules between resources within the same computing device 103. For example, logical rules 106a-e could be assigned to a first central processor unit (CPU) core, but logical rules 106d and 106e could be reassigned to a second CPU core of the same CPU or a second CPU core of a second CPU.

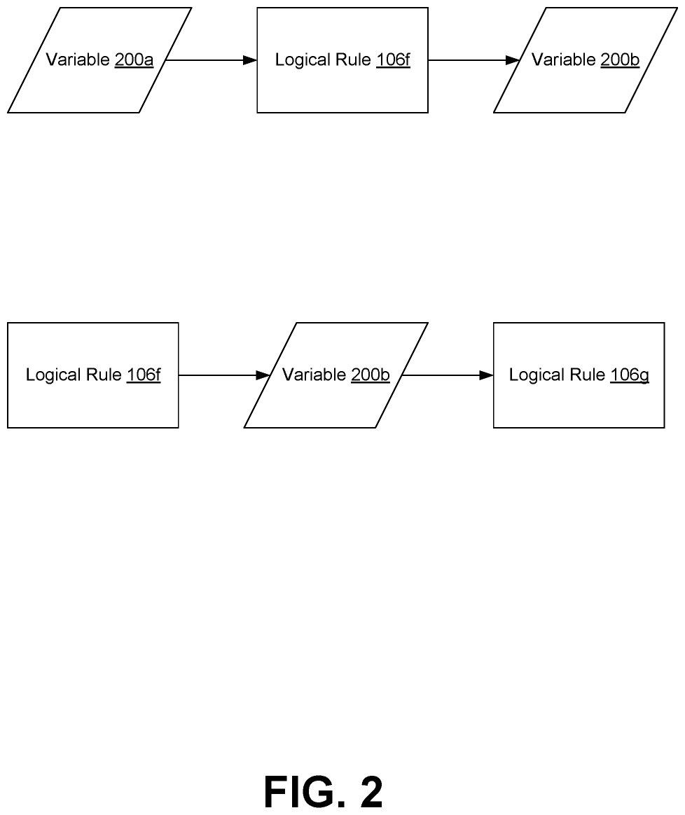

FIG. 2 depicts how individual logical rules 106 can be represented as nodes with edges connecting a logical rule 106 to variables 200. The graph formed by the nodes and edges can be used to identify dependencies between individual logical rules 106 for subsequent optimization and/or parallelization. Edges may be unidirectional or bidirectional. For example, a logical rule 106f could have two edges connecting the logical rule 106f to a first variable 200a and a second variable 200b. The first variable 200a could be an input variable 200 that the logical rule 106f reads data from as part of the execution or evaluation of the logical rule 106f. The second variable 200b could be a variable where a resulting value from the execution or evaluation of the logical rule 106f is stored. Accordingly, any logical rule 106 (e.g., logical rule 106g) that takes variable 200b as an input is dependent on any logical rule 106 (e.g., logical rule 106f) that writes data to, or modifies the data saved in, variable 200b.

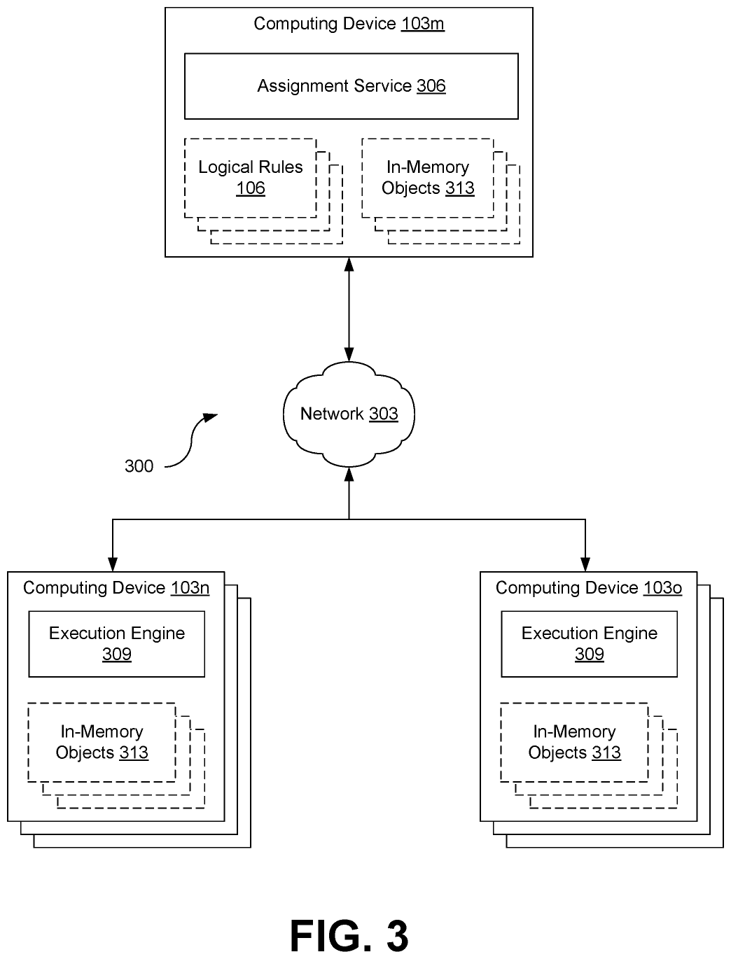

With reference to FIG. 3, shown is a network environment 300 according to various embodiments. The network environment 300 can one or more computing devices 103, which can be in data communication with each other via a network 303. As illustrative examples for discussion purposes, computing devices 103m and 103n are depicted and specifically referenced in order to describe the operations of the various embodiments of the present disclosure.

The network 303 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 303 can also include a combination of two or more networks 303. Examples of networks 303 can include the Internet, intranets, extranets, virtual private networks (VPNs), and similar networks.

The computing devices 103 can include any physical or virtual computer that include a physical or virtual processor, a physical or virtual memory, and/or a physical or virtual network interface. For example, the computing devices can be configured to perform computations on behalf of other computing devices or applications. As another example, such computing devices can host and/or provide content to other computing devices in response to requests for content.

Moreover, the computing devices that can be arranged in one or more collections, clusters, groups, or other arrangements of computing devices. Such computing devices can be located in a single installation or can be distributed among many different geographical locations. For example, the computing devices can include a hosted computing resource, a grid computing resource or any other distributed computing arrangement. In some cases, a computing device can correspond to an elastic computing resource where the allotted capacity of processing, network, storage, or other computing-related resources can vary over time.

As previously mentioned, the computing devices can be physical or virtual computers. The virtual computers, which can also be referred to as virtual machines or virtual compute instances, can have varying computational and/or memory resources, which are managed by a compute virtualization service (referred to in various implementations as an elastic compute service, a virtual machines service, a computing cloud service, a compute engine, or a cloud compute service). In one embodiment, each of the virtual compute instances may correspond to one of several instance types or families. An instance type may be characterized by its hardware type, computational resources (e.g., number, type, and configuration of central processing units [CPUs] or CPU cores), memory resources (e.g., capacity, type, and configuration of local memory), storage resources (e.g., capacity, type, and configuration of locally accessible storage), network resources (e.g., characteristics of its network interface and/or network capabilities), and/or other suitable descriptive characteristics. Each instance type can have a specific ratio of processing, local storage, memory, and networking resources, and different instance families may have differing types of these resources as well. Multiple sizes of these resource configurations can be available within a given instance type. Using instance type selection functionality, an instance type may be selected for a customer, e.g., based (at least in part) on input from the customer. For example, a customer may choose an instance type from a predefined set of instance types. As another example, a customer may specify the desired resources of an instance type and/or requirements of a workload that the instance will run, and the instance type selection functionality may select an instance type based on such a specification. It will be appreciated that such virtual machines or virtualized compute instances may also be able to run in other environments, for example on the premises of customers, where such on-premise instances may be managed by a cloud provider or a third party.

In some embodiments, the execution of virtual machines or virtual compute instances is supported by a lightweight virtual machine manager (VMM). These VMMs enable the launch of lightweight micro-virtual machines (microVMs) in non-virtualized environments in fractions of a second. Accordingly, a computing device 103 implemented as a virtual machine or virtual compute instance could be implemented as a microVM.

These VMMs can also enable container runtimes and container orchestrators to manage containers as microVMs. These microVMs nevertheless take advantage of the security and workload isolation provided by traditional VMs and the resource efficiency that comes along with containers, for example by being run as isolated processes by the VMM. A microVM, as used herein, refers to a VM initialized with a limited device model and/or with a minimal OS kernel that is supported by the lightweight VMM, and which can have a low memory overhead, such that thousands of microVMs can be packed onto a single host. For example, a microVM can have a stripped-down version of an OS kernel (e.g., having only the required OS components and their dependencies) to minimize boot time and memory footprint. In one implementation, each process of the lightweight VMM encapsulates one and only one microVM. The process can run the following threads: API, VMM and vCPU(s). The API thread is responsible for the API server and associated control plane. The VMM thread exposes a machine model, minimal legacy device model, microVM metadata service (MMDS), and VirtIO device emulated network and block devices. In addition, there are one or more vCPU threads (one per guest CPU core). A microVM can be used in some implementations to run a containerized workload.

Various applications or other functionality can be executed by the computing devices 103. In some implementations, each computing device 103 could be configured to execute the same applications or services. In other implementations, different computing devices 103 could perform different roles and, therefore, be configured to execute different applications or services that work together. For example, a computing device 103 could be configured to execute both an assignment service 306 and an execution engine 309. In other instances, one computing device 103, such as computing device 103m, could be configured to execute the assignment service 306, while other computing devices 103, such as computing devices 103n and 103o, could be separately configured to execute the execution engine 309.

The assignment service 306 can be executed to perform various tasks related to the optimization and/or parallelization of workloads involving one or more logical rules 106. For example, the assignment service 306 could convert logical rules 106 into in-memory objects 313 that represent computer-executable code for respective logical rules 106. The assignment service 306 could also analyze logical rules 106 or in-memory objects 313 to determine dependencies between the logical rules 106 or in-memory objects 313. The assignment service 306 could further be executed to assign groups of in-memory objects 313 to individual computing devices 103 (e.g., computing devices 103n, 103o, etc.) for execution in parallel, as well as migrate or reassign in-memory objects 313 from one computing device 103 to another computing device 103 to improve performance as workloads change. Accordingly, the assignment service 306 could be executed to test or measure the performance of execution of in-memory objects 313 assigned to different computing devices 103 to determine an optimal assignment for performance of the in-memory objects 313. Accordingly, the assignment service 306 could also be executed to track available computing devices 103 and performance information about said computing devices 103 (e.g., number of processors; processor cores; amount of memory; amount of network bandwidth; availability of processors, processor cores, memory or network bandwidth; etc.).

The execution engine 309 can be configured to, programmed to, or operated to execute the in-memory objects 313 assigned to the computing device 103. This can include reading data from any variables relied upon as inputs by the in-memory objects 313, executing any instructions specified by the in-memory objects 313, and storing the results of any execution or evaluation to a respective variable or variables specified by the in-memory object 313. In some implementations, the execution engine 309 could represent a runtime environment or interpreter that can read in-memory objects 313 and cause various tasks or calculations specified by the in-memory objects 313 to be performed.

The logical rules 106 can represent human-readable statements that specify rules to be followed or enforced, actions to be performed, conditions to be evaluated (e.g., as a trigger for an action or as a definition for a rule), etc. The logical rules 106 can also specify variables 200 containing values to be used as inputs or variables 200 to be used to store results.

Logical rules 106 can be generated or formatted in any number of ways. For example, logical rules 106 could be created using low-code or no-code tools that allow for rapid application development (RAD) through the use of visual building blocks such as drag-and-drop blocks representing actions, triggers, conditions, rules, etc. that can be linked together to quickly generate an application using process modelling or similar approaches. Logical rules 106 could also be created using various scripting languages to quickly create individual logical rules 106 that rely upon various specified variables 200. Logical rules 106 could, in various embodiments, represent workflows, business rules, or various other processes.

Each in-memory object 313 can represent machine-executable object code for respective logical rules 106. Each in-memory object 313 can include a list of variables 200 to be used as inputs or for outputs results to be stored in. Each in-memory object 313 can also include one or more instructions to allow a computing device 103 to execute or evaluate the respective logical rule 106.

Next is a general description of the operation of the various components of the network environment 300 according to various embodiments of the present disclosure. Although the following general description provides an example of the operation of, and interactions between, the components of the network environment 300, other operations and interactions are also encompassed by the present disclosure.

To begin, one or more logical rules 106 are specified or created and provided to the assignment service 306. The logical rules 106 could be created using various approaches. For example, the logical rules 106 could be created using low-code or no-code tools, scripting languages, or combinations thereof. The logical rules 106, once created, can then be provided to the assignment service 306.

The assignment service 306 can create an in-memory object 313 for each logical rule 106. For example, the assignment service 306 could parse and compile each logical rule 106 into machine-readable code that could be executed by a processor of a computing device 103. As another example, the assignment service 306 could parse and compile each logical rule 106 into intermediate bytecode that could be executed by a runtime environment or interpreter, such as the execution engine 309 in some implementations or embodiments.

The assignment service 306 can also group the in-memory objects 313 together into groups of related objects that represent groups of related logical rules 106. To do this, the assignment service 306 can identify dependencies between the logical rules 106 and, therefore, between the in-memory objects 313. This could be done by analyzing the variables shared between in-memory objects 313 or by analyzing the variables shared by logical rules 106. All of the in-memory objects 313 that are linked together can represent logical rules 106 that are linked together. Separate or independent groups of in-memory objects 313 are then identified. A group of in-memory objects 313 can be considered separate or independent if there are no variables 200 shared between the two groups of in-memory objects 313 that require data to be written or stored to it. Groups of in-memory objects 313 can be considered separate or independent if they read data from the same, static variable 200 (e.g., a variable that contains an initial value that will not change or be changed). Meanwhile, groups of in-memory objects 313 would not be considered to be separate or independent if an in-memory object 313 in one group read data from a variable 200 modified by an in-memory object 313 of another group.

The assignment service 306 can then assign the separate, independent groups of in-memory objects 313 to separate computing devices 103 (or separate computing resources within the same computing device 103). By assigning the separate, independent groups of in-memory objects 313 to separate computing devices 103 (e.g., computing devices 103n and 103o) or separate computing resources (e.g., separate CPUs or separate CPU cores) on the same computing device 103, the in-memory objects 313 can be executed in parallel. Where the separate, independent groups of in-memory objects 313 represent independent portions of the same workflow, process, or application, this can result in improved performance for the workflow, process, or application due to parallelization. Similarly, where the separate, independent groups of in-memory objects 313 represent separate workflows, processes, or applications, this can result in improved performance by allowing for the workflows, processes, or applications to be executed in parallel.

The assignment service 306 can periodically monitor the performance of the groups of in-memory objects 313 assigned to the various computing devices 103. As part of the monitoring, the assignment service 306 can migrate the separate, independent groups of in-memory objects 313 between computing devices 103 to determine if performance would improve or decrease. For example, if a computing device 103 were hosting two separate, independent groups of in-memory objects 313 for execution, the assignment service 306 could cause one of the two groups to be migrated to another computing device 103 in order to determine if there were any improvement in the execution performance of either group of in-memory objects 313. If a performance increase were identified, then the reassignment could remain. If no performance increase were identified or if a performance decrease were identified, then the reassignment could be reverted.

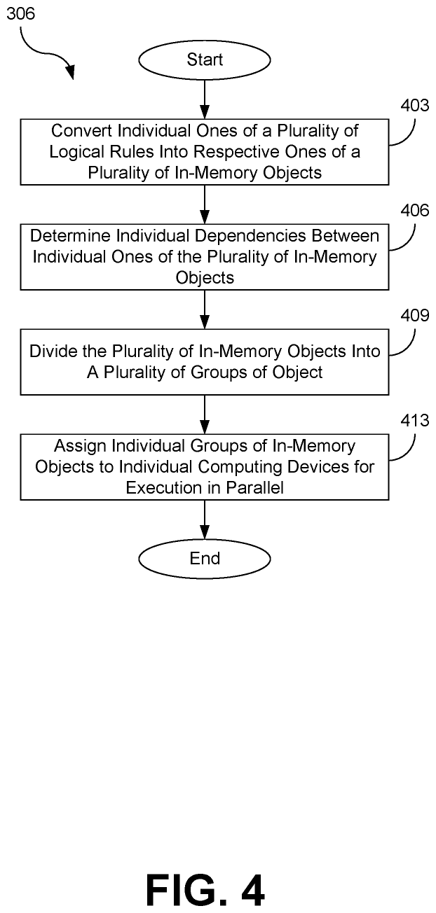

Referring next to FIG. 4, shown is a flowchart that provides one example of the operation of a portion of the assignment service 306. The flowchart of FIG. 4 provides merely an example of the many different types of functional arrangements that can be employed to implement the operation of the depicted portion of the assignment service 306. As an alternative, the flowchart of FIG. 4 can be viewed as depicting an example of elements of a method implemented within the network environment 300.

Beginning with block 403, the assignment service 306 can convert individual ones of a plurality of logical rules 106 into respective ones of a plurality of in-memory objects 313. For example, the assignment service 306 could parse and compile each logical rule 106 into machine-readable code that could be executed by a processor of a computing device 103. As another example, the assignment service 306 could parse and compile each logical rule 106 into intermediate bytecode that could be executed by a runtime environment or interpreter, such as the execution engine 309 in some implementations or embodiments.

Next, at block 406, the assignment service 306 can determine individual dependencies between individual ones of the plurality of in-memory objects 313. This could be done by analyzing the variables shared between in-memory objects 313 or by analyzing the variables shared by logical rules 106 for the respective in-memory objects 313. Because each logical rule 106, and therefore each in-memory object 313, can be represented as a node in a graph that includes one or more edges linking the in-memory object 313 or logical rule 106 to one or more variables 200, the assignment service 306 could do a depth first search or breadth first search to build a graph from a root in-memory object 313 for a respective root logical rule 106.

For example, logical rules 106 could be marked or indicated as root logical rules 106 to allow for respective in-memory objects 313 to be denoted as root in-memory objects 313. For example, in FIG. 1, logical rules 106a, 106b, and 106d could be marked as root logical rules 106, allowing for respective in-memory objects 313 to be denoted as root in-memory objects 131. A graph of dependent logical rules 106 or in-memory objects 313 could then be identified using a depth first search, breadth first search, or similar technique to find dependent logical rules 106 or in-memory objects 313.

Moving on to block 409, the assignment service 306 can divide the plurality of in-memory objects 313 into a plurality of groups of in-memory objects 313. For example, the assignment service 306 could search for groups of in-memory objects 313 represented as separate or disconnected graphs. Each separate or disconnected graph of in-memory objects 313 could represent a group of in-memory objects 313.

Subsequently, at block 413, the assignment service 306 can assign individual groups of in-memory objects 313 to individual computing devices 103 for execution of the groups of in-memory objects 313 in parallel. Multiple groups of in-memory objects 313 could be assigned to the same computing device 103 in some instances. The assignment could be done using a variety of approaches. For example, individual groups of in-memory objects 313 could be assigned to individual computing devices 103 on a round-robin basis. As another example, individual groups of in-memory objects 313 could be assigned to computing devices 103 based at least in part on available resources of the individual computing devices 103. Individual groups of in-memory objects 313 that have a larger number of in-memory objects 313 could, for example, be assigned to a computing device 103 with more processors or processor cores, more memory, etc.

Moreover, groups of in-memory objects 313 could be assigned to individual computing devices 103 using various groupings. For example, in some instances, groups of in-memory objects 313 could be assigned to a computing device 103 in groups of execution chains, where separate groups of in-memory objects 313 can run concurrently on the same computing device 103. In other instances, groups of in-memory objects 313 could be assigned to computing device 103 as execution groups, where only one group of in-memory objects 313 can be processed or execute at a time.

Alternatively, the assignment service 306 can assign individual groups of in-memory objects 313 to individual computing resources of a computing device 103. For example, the assignment service 306 could assign a first group of in-memory objects 313 to execute on a first central processor unit (CPU) or CPU core and a second group of in-memory objects 313 to execute on a second CPU or CPU core of the same computing device 103. Meanwhile, the assignment service 306 could assign remaining groups of in-memory objects 313 to other computing devices 103 (including other CPUs or CPU cores of other computing devices 103).

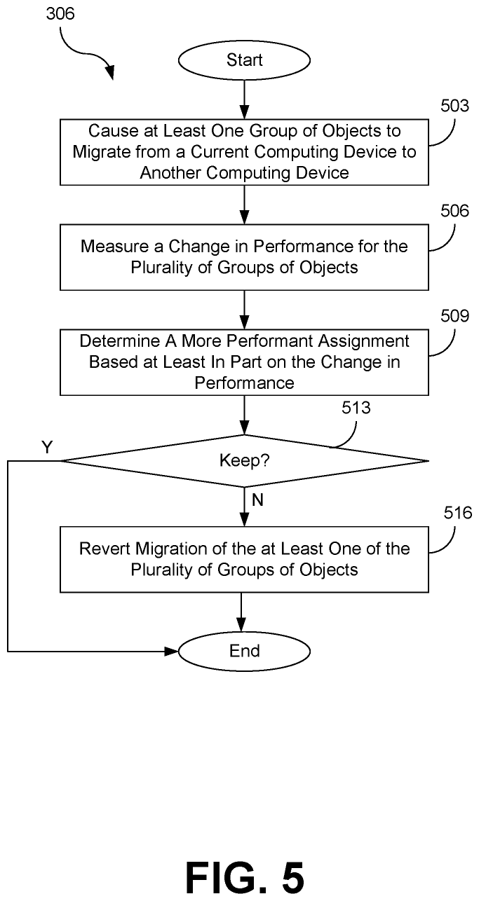

Referring next to FIG. 5, shown is a flowchart that provides one example of the operation of a portion of the assignment service 306. The flowchart of FIG. 5 provides merely an example of the many different types of functional arrangements that can be employed to implement the operation of the depicted portion of the assignment service 306. As an alternative, the flowchart of FIG. 5 can be viewed as depicting an example of elements of a method implemented within the network environment 300.

Beginning with block 503, the assignment service 306 can cause at least one group of in-memory objects 313 to migrate in order to determine if a different assignment of in-memory objects 313 would result in better performance of the system. For example, the assignment service 306 could cause at least one group of in-memory objects 313 to migrate from a current computing device 103 (e.g., computing device 103n) to another computing device 103 (e.g., computing device 103o). As another example, the assignment service 306 could cause at least one group of in-memory objects 313 to migrate from one computing resource to another computing resource, such as from one central processing unit (CPU) or CPU core to another CPU or CPU core of the same computing device 103 or to a different CPU or CPU core on another computing device 103.

Migration of the group of in-memory objects 313 could be initiated using various approaches. For example, the assignment service 306 could send a message or command to the current computing device 103 that causes the current computing device 103 to copy or otherwise migrate the in-memory objects 313 in the group to the other computing device 103 or to another CPU or CPU core on the same computing device 103. The identity of the other computing device 103 could be specified or identified in the message sent by the assignment service 306. As another example, the assignment service 306 could send copies of the in-memory objects 313 in the group of in-memory objects 313 to the second or other computing device 103 (e.g., from computing device 103m to computing device 103o) and send a message to the first or current computing device 103 (e.g., computing device 103n) to delete or remove the in-memory objects 313 currently hosted by it.

The other computing device 103 (e.g., computing device 103o) could be selected by the assignment service 306 using various approaches. For example, the other computing device 103 could be selected on a round-robin basis from a group of computing devices 103 available to the assignment service 306. As another example, the other computing device 103 could be selected by the assignment service 306 based at least in part on the available resources of the other computing device 103. For example, the assignment service 306 could select the other computing device 103 on the basis of it having more available processors or processor cores, memory, bandwidth, etc., which could be used to potentially better execute or evaluate a large group of in-memory objects 313. As a similar example, the assignment service 306 could select the other computing device 103 on the basis of it having fewer available processors or processor cores, memory, bandwidth, etc., and therefore being more appropriately sized for executing a smaller group of in-memory objects 313 without impacting performance.

Similarly, if the group of in-memory objects 313 were to be migrated from one CPU or CPU core on the computing device 103 to another CPU or CPU core on the same computing device 103 or to another CPU or CPU core on the other computing device 103, the destination CPU or CPU core could be selected using the same or similar approaches. For example, a destination CPU or CPU core on the computing device 103 or the other computing device 103 could be selected because it has a lot utilization rate, a large number of free or unused CPU cores, etc.

Next, at block 506, the assignment service 306 could measure, determine or otherwise identify a change in performance for all of the groups of in-memory objects 313 assigned to various computing devices 103 or computing resources (e.g., CPUs or CPU cores). This could be done to determine not only whether moving or migrating the group of in-memory objects 313 between computing devices 103 impacted the performance related to executing or evaluating those in-memory objects 313, but could also be done to determine whether moving or migrating the group of in-memory objects 313 between computing devices 103 impacted the performance of other groups of in-memory objects 313 on either computing device 103.

For example, the assignment service 306 could send a request to the execution engine 309 of each computing device 103 to measure how quickly the execution or evaluation of the in-memory objects 313 hosted by the respective computing devices 103 (including specific CPUs or CPU cores) occurs. The execution engine 309 could then profile or otherwise measure the performance of multiple executions or evaluations of the in-memory objects 313 to determine an average measure of performance.

Moving on to block 509, the assignment service 306 can determine a more performant assignment of in-memory objects 313 to computing devices 103 or specific computing resources (e.g., specific CPUs or CPU cores of computing devices 103) based at least in part on the changes in performance measured at block 506. For example, the assignment service 306 could determine whether the performance of the migrated in-memory objects 313 was better when hosted by the first computing device 103 (e.g., computing device 103n) or the second computing device 103 (e.g., computing device 103o). Similarly, the assignment service 306 could determine whether the performance of the migrated in-memory objects 313 was better when executing on a first CPU or CPU core or a second CPU or CPU core. Moreover, the assignment service 306 could determine whether and/or by how much the performance of other in-memory objects 313 was impacted by the migration.

Then, at block 513, the assignment service 306 could determine whether to keep the in-memory objects 313 assigned to the second computing device 103 (e.g., computing device 103o), CPU, or CPU core. The decision could be made based at least in part on which assignment of a computing device 103 for the migrated group of in-memory objects 313 offered better performance for the in-memory objects 313 or for other in-memory objects 313 that were not migrated or reassigned. If the determination is made to keep the in-memory objects 313 assigned to the second computing device 103, CPU, or CPU core, then the process could end. However, if the determination is made to not keep the in-memory objects 313 assigned to the second computing device 103, then the process could proceed to block 516.

If the process proceeds to block 516, the assignment service 306 could revert the migration of the group of in-memory objects 313 from the second computing device 103 (e.g., computing device 103o), CPU, or CPU core, back to the original computing device 103 (e.g., computing device 103n), CPU, or CPU core.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a first computing device comprising a processor and a memory; and
machine-readable instructions stored in the memory that, when executed by the processor, cause the computing device to at least:
determine individual dependencies between individual ones of a plurality of objects stored in the memory, each of the plurality of objects comprising a node representing a logical rule and at least one edge representing variable linked to the logical rule;
divide the plurality of objects into a plurality of groups of objects based at least in part on the individual dependencies between the individual ones of the plurality of objects, wherein individual objects within individual ones of the plurality of groups of objects are independent of individual objects within other ones of the plurality of groups of objects; and
assign individual ones of the plurality of groups of objects to individual computing devices for execution in parallel, the individual computing devices being separate from the first computing device.

2. The system of claim 1, wherein the machine-readable instructions further cause the first computing device to at least:
convert individual ones of a plurality of logical rules into respective ones of the plurality of objects.

3. The system of claim 1, wherein the machine-readable instructions further cause the first computing device to at least determine a more performant assignment of the individual ones of the plurality of groups of objects to individual computing devices.

4. The system of claim 3, wherein the machine-readable instructions further cause the computing device to at least:
cause at least one group of objects to migrate from a current computing device to another computing device;
measure a change in performance for the plurality of groups of objects; and
determine the more performant assignment based at least in part on the change in performance.

5. The system of claim 4, wherein the machine-readable instructions further cause the computing device to at least revert migration of the at least one group of objects.

6. The system of claim 1, wherein the machine-readable instructions that cause the first computing device to at least assign individual ones of the plurality of groups of objects to individual computing devices further cause the first computing device to at least assign the individual ones of the plurality of groups of objects in execution chains.

7. The system of claim 1, wherein the machine-readable instructions that cause the first computing device to at least assign individual ones of the plurality of groups of objects to individual computing devices further cause the first computing device to at least assign the individual ones of the plurality of groups of objects in execution groups.

8. A method, comprising:
determining individual dependencies between individual ones of a plurality of objects stored in a memory of a first computing device, each of the plurality of objects comprising a node representing a logical rule and at least one edge representing variable linked to the logical rule;
dividing the plurality of objects into a plurality of groups of objects based at least in part on the individual dependencies between the individual ones of the plurality of objects, wherein individual objects within individual ones of the plurality of groups of objects are independent of individual objects within other ones of the plurality of groups of objects; and
assigning individual ones of the plurality of groups of objects to individual computing devices for execution in parallel, the individual computing devices being separate from the first computing device.

9. The method of claim 8, further comprising converting individual ones of a plurality of logical rules into respective ones of the plurality of objects.

10. The method of claim 8, further comprising determining a more performant assignment of the individual ones of the plurality of groups of objects to individual computing devices.

11. The method of claim 10, further comprising:
causing at least one group of objects to migrate from a current computing device to another computing device;
measuring a change in performance for the plurality of groups of objects; and
determining the more performant assignment based at least in part on the change in performance.

12. The method of claim 11, further comprising reverting migration of the at least one group of objects.

13. The method of claim 8, further comprising assigning individual ones of the plurality of groups of objects to individual computing devices further cause the first computing device to at least assign the individual ones of the plurality of groups of objects in execution chains.

14. The method of claim 8, further comprising assigning individual ones of the plurality of groups of objects to individual computing devices further cause the first computing device to at least assign the individual ones of the plurality of groups of objects in execution groups.

15. A non-transitory, computer-readable medium, comprising machine-readable instructions that, when executed by a processor of a first computing device, cause the computing device to at least:
determine individual dependencies between individual ones of a plurality of objects stored in a memory of the first computing device, each of the plurality of objects comprising a node representing a logical rule and at least one edge representing variable linked to the logical rule;
divide the plurality of objects into a plurality of groups of objects based at least in part on the individual dependencies between the individual ones of the plurality of objects, wherein individual objects within individual ones of the plurality of groups of objects are independent of individual objects within other ones of the plurality of groups of objects; and
assign individual ones of the plurality of groups of objects to individual computing devices for execution in parallel, the individual computing devices being separate from the first computing device.

16. The non-transitory, computer-readable medium of claim 15, wherein the machine-readable instructions further cause the first computing device to at least:
convert individual ones of a plurality of logical rules into respective ones of the plurality of objects.

17. The non-transitory, computer-readable medium of claim 15, wherein the machine-readable instructions further cause the first computing device to at least determine a more performant assignment of the individual ones of the plurality of groups of objects to individual computing devices.

18. The non-transitory, computer-readable medium of claim 17, wherein machine-readable instructions further cause the computing device to at least:
cause at least one group of objects to migrate from a current computing device to another computing device;
measure a change in performance for the plurality of groups of objects; and
determine the more performant assignment based at least in part on the change in performance.

19. The non-transitory, computer-readable medium of claim 15, wherein the machine-readable instructions that cause the first computing device to at least assign individual ones of the plurality of groups of objects to individual computing devices further cause the first computing device to at least assign the individual ones of the plurality of groups of objects in execution groups.

20. The non-transitory, computer-readable medium of claim 15, wherein the machine-readable instructions that cause the first computing device to at least assign individual ones of the plurality of groups of objects to individual computing devices further cause the first computing device to at least assign the individual ones of the plurality of groups of objects in execution chains.
